(19) United States
(12) Patent Application Publication
(10) Pub. No.: US 2006/0266798 A1
(43) Pub. Date: Nov. 30, 2006

(54) Weld fastener for use in projection welding process

(76) Inventors: Narayanan P. Menon, Bloomfield Hills, MI (US); Mark D. Gugel, Shelby Township, MI (US); James F. Hengel, Romeo, MI (US)

Correspondence Address: General Motors Corporation;Legal Staff, Mail Code 482-C23-B21, P.O. Box 300, Detroit, MI, 48265-3000, US

(21) Appl. No.: 11/137,051

(22) Filed: May 25, 2005

(51) Int. Cl. A47J 36/02

(52) U.S. Cl. 228/101

(57) ABSTRACT

A weld fastener for use in a projection welding process includes a fastener body having a planar surface with at least one weld projection extending therefrom. The weld projection includes a free end spaced from the planar surface that defines a weld plane. The fastener body includes an interior wall defining an aperture extending through at least one end of the fastener body. A portion of the interior wall defines a thread starting plane. The weld plane and the thread starting plane are spaced apart by a first predetermined distance. The planar surface and the thread starting plane are spaced apart by a second predetermined distance.

### BACKGROUND OF THE INVENTION

The present invention relates generally to projection welding fasteners and, in particular, to a weld fastener for use in a projection welding process.

Weld fasteners are used in projection welding processes and typically include a weld fastener body having at least one projection extending from a weld surface and an aperture extending through at least one end of the fastener body and having threads formed thereon. In a projection welding process, the projection is pressed to a parent metal surface adjacent an aperture in the parent metal surface and subsequently fused with the parent metal by passing a high electrical current (typically for a predetermined time) through the parent metal, the projection, and the fastener. The high electrical current softens or melts the projections, which begin to be fused with the parent metal. Typically, as the projections begin to soften or melt, the applied force to the fastener body increases the fusion between the fastener and the parent metal.

While the high current is flowing, however, molten metal from the projections has the potential to expel from the projections and strike the aperture, causing difficulty when later utilizing the fastener. The prior art has attempted different approaches to mitigate this possibility, including utilizing an extension or pilot on the fastener that extends into the aperture in the parent metal surface and prevents weld splatter from getting to the aperture on the fastener. The fasteners including the pilots, however, have the potential of shunting the weld current and causing an unstable weld process. Another approach is to space the weld projection radially outwardly from the aperture, which makes the fastener footprint large and could lead to packaging issues.

It is desirable, therefore, to provide a weld fastener for use in a projection welding process that prevents molten metal from reaching an aperture extending through the fastener body and that provides a smaller footprint for the fastener and reduces the potential of shunting the weld current during the projection welding process.

### SUMMARY OF THE INVENTION

The present invention concerns a weld fastener for use in a projection welding process. The weld fastener includes a fastener body having a planar surface with at least one weld projection extending therefrom. The weld projection includes a free end spaced from the planar surface that defines a weld plane. The fastener body includes an interior wall defining an aperture extending through at least one end of the fastener body. A portion of the interior wall defines a thread starting plane. The weld plane and the thread starting plane are spaced apart by a first predetermined distance. The planar surface and the thread starting plane are spaced apart by a second predetermined distance.

Alternatively, the aperture extending through the fastener body includes threads formed thereon. The first and second predetermined distances are selected to be great enough such that if molten metal from the projections is expelled from the projections during a projection welding process, the molten metal is prevented from striking the interior wall defining the aperture or the threads in the aperture because of the distance and/or the angle at which the molten metal would have to travel in order to impact the interior wall defining the aperture or the threads.

The interior wall defining the aperture and/or the threads in the aperture, therefore, are protected from molten metal during the projection welding process without requiring the use of a pilot or similar structure, reducing the potential of shunting the weld current during the projection welding process. The fastener body in accordance with the present invention also does not require a large footprint for spacing the projections away from the fastener because the separation of the thread starting plane and the weld plane does not require the projections to be spaced radially outwardly from the aperture.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a weld projection nut of the prior art;

FIG. 2 is an elevation view of the weld projection nut of FIG. 1;

FIG. 3 is a perspective view of another weld projection nut of the prior art;

FIG. 4 is a bottom plan view of the weld projection nut of FIG. 3;

FIG. 5 is an elevation view of a weld fastener in accordance with the present invention;

FIG. 6 is a view of a cross sectional view of the weld fastener of FIG. 5;

FIG. 7 is a cross-sectional view of weld fastener of FIG. 6 shown welded to a surface of a parent metal;

FIG. 8 is a perspective view of a weld fastener in accordance with the present invention having a plurality of discrete projections; and

FIG. 9 is a perspective view of a weld fastener in accordance with the present invention having a continuous projection.

### DESCRIPTION OF THE PREFERRED EMBODIMENT

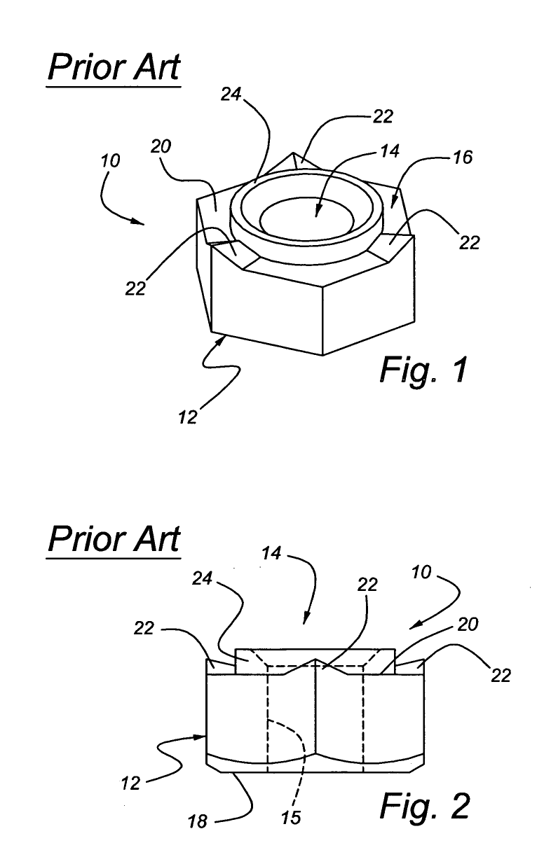

Referring now to FIGS. 1 and 2, a weld fastener in accordance with the prior art is indicated generally at 10. The weld fastener 10 includes a fastener body 12 having an aperture 14 extending through a first end 16 and a second end 18 thereof. The aperture 14 is defined by an interior wall 15 of the fastener body 12. The interior wall 15 preferably includes a plurality of threads formed thereon. The first end 16 includes a planar surface 20 having a plurality of projections 22 extending therefrom and spaced radially outwardly from an extension or pilot 24. A free end of the pilot 24 extends beyond a plane defined by the free ends of the projections 22 and extends into an aperture in a parent metal surface (not shown) during a projection welding process. As a high electrical current flows through the fastener body 12, the projections 22 and the parent metal surface, the pilot 24 prevents weld splatter from the projections 22 from getting to the aperture 14 on the fastener body 12. Weld fasteners 10 that include the pilots 24, however, have the potential of shunting the weld current from the projections 22 to the pilot 24 and therefore cause an unstable weld process.

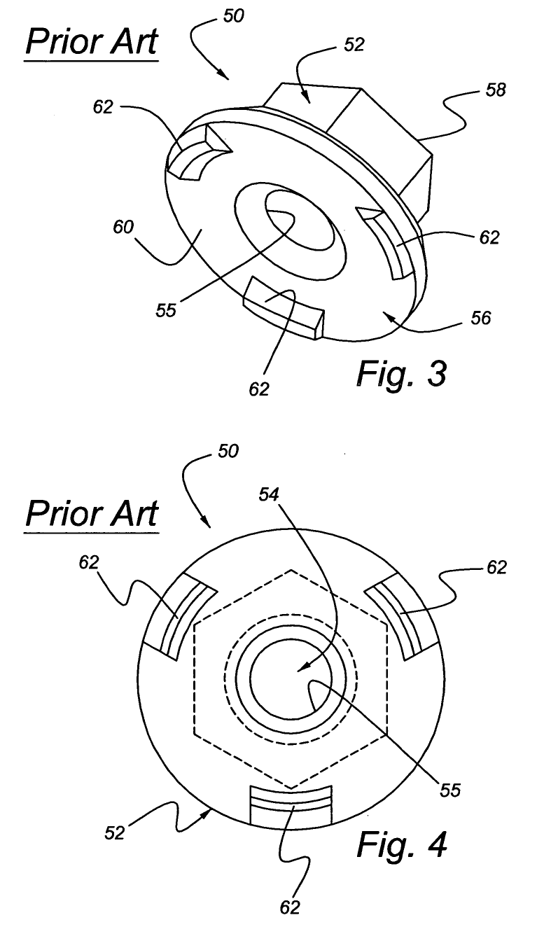

Referring now to FIGS. 3 and 4, another weld fastener in accordance with the prior art is indicated generally at 50. The weld fastener 50 includes a fastener body 52 having an aperture 54 extending through a first end 56 and a second end 58 thereof. The aperture 54 is defined by an interior wall 55 of the fastener body 52. The interior wall 55 preferably includes a plurality of threads formed thereon. The first end 56 includes a flange extending radially outwardly therefrom and defining a planar surface 60. The planar surface 60 includes a plurality of projections 62 extending from the radial outward edge thereof. By radially spacing the weld projections 62 away from the aperture 54, the possibility of weld spatter getting to the aperture 14 is reduced. The footprint of the fastener body 52, however, is disadvantageously large because of the radially outwardly extending planar surface 60 and could lead to packaging issues.

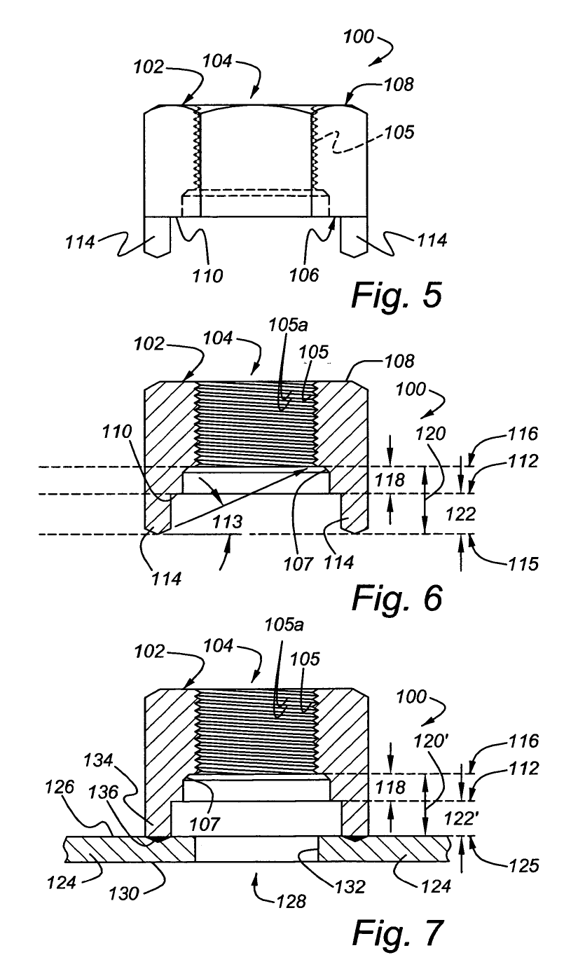

Referring now to FIGS. 5-9, a weld fastener for use in a projection welding process in accordance with the present invention is indicated generally at 100. The weld fastener 100 includes a fastener body 102 having an aperture 104 extending through a first end 106 and a second end 108 thereof. The aperture 104 is defined by an interior wall 105 of the fastener body 102. Alternatively, the aperture 104 extends through only a one of the first end 106 and the second end 108. The interior wall 105 preferably includes a plurality of threads 105a, best seen in FIGS. 7 and 8, formed thereon. The interior wall 105 includes a chamfered portion 107 on a leading edge thereof. Alternatively, the interior wall 105 does not include threads formed thereon and threads, such as the threads 105a, are formed in the interior wall 105 by a tap (not shown) or the like after the weld fastener has been subjected to a projection welding process, discussed in more detail below.

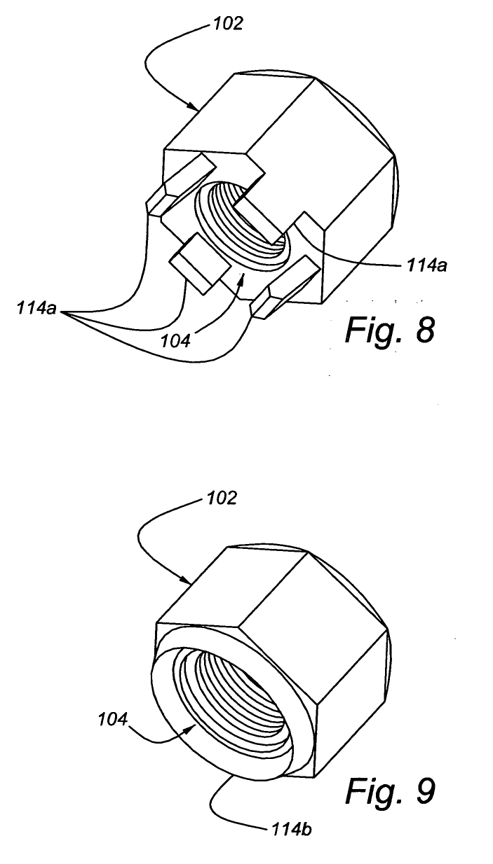

The first end 106 of the fastener body 102 defines a planar surface 110 that defines a surface plane, indicated by an arrow 112. The planar surface 110 includes at least one weld projection 114 extending therefrom. The projection 114 may be a plurality of discrete projections, such as the projections 114a shown in FIG. 8. Alternatively, the projection 114 may be a continuous projection extending circumferentially about the aperture 104 in the planar surface 110, such as the projections 114b shown in FIG. 9. A free end of the at least one weld projection 114 defines a weld plane, indicated by an arrow 115.

The fastener body 102 and the projection 114 are preferably formed of a metallic material such as a steel alloy or the like. A portion of interior wall 105 defines a thread starting plane, indicated by an arrow 116. The thread starting plane 116 is the plane at which the threads are first formed on the interior wall 105 and is adjacent the chamfered portion 107. The thread starting plane 116 is spaced apart from the surface plane 112 by a predetermined distance, indicated by an arrow 118. The weld plane 115 is spaced apart from the thread starting plane 116 by a predetermined distance 120 and from the surface plane 112 by a predetermined distance 122. The weld plane 115 is preferably substantially parallel to the thread starting plane 116. The thread starting plane 116 is preferably substantially parallel to the surface plane 112.

In operation, the fastener body 102 of the weld fastener 100 is placed adjacent or pressed against a parent metal body 124 having a working surface 126. The parent metal body 124 is preferably a vehicle body panel, a vehicle frame member, or the like and includes an aperture 128 extending through the working surface 126 and a lower surface 130 and defined by an interior surface 132. Alternatively, no aperture is formed through the parent metal body 124.

The fastener body 102 and the parent metal body 124 are connected to a projection welding apparatus (not shown) or the like, which are well known to those skilled in the art, and the free ends of the projections 114 are placed in contact with or abut the working surface 126 and subjected to a projection welding process. In the projection welding process, a high electrical current from the projection welding apparatus is passed through the fastener body 102, the projections 114, and the parent metal body 124. As the high electrical current flows through the fastener body 102, the projections 114, and the parent metal body 124, the smaller surface area of the projections 114 begins to soften or melt and fuse with the parent metal body 124. Typically, as the projections 114 begin to soften or melt, the pressing force applied to the fastener body 102 increases the fusion between the fastener body 102 and the parent metal body 124. The electrical current is then stopped after a predetermined period of time, after which the softened and/or molten metal of the projections 114 cools to form a weld 134 having a thickness 122′ at an interface 136 between the projections 114 and the parent metal body 124, best seen in FIG. 7. After the weld 134 has formed, a distance 120′ between the thread starting plane 116 and a plane 125 of the working surface 126 is obviously reduced in comparison with the distance 120 before the projection welding process. The distance 118 between the surface plane 112 and the thread starting plane 116 remains the same after the projection welding process.

The distances 118 and 120 are selected to be great enough such that if molten metal from the projections 114 is expelled from the projections 114 during a projection welding process, the molten metal is prevented from striking either the surface 105 or the threads 105a formed in the surface 105 of the aperture 104 because the molten metal would not be able to travel the distance 120.

Preferably, the distance 120 is determined by an angle 113 between the free end of the projection 114 on the weld plane 115 and the thread starting plane 116. For example, in a weld fastener 102 having an outside diameter of 15.5 millimeters and an aperture 104 sized for an bolt known to those skilled in the art as an M6×1.0 bolt with a diameter equal to 6.0 millimeters, the distance 118 between the thread starting plane 116 and the surface plane 112 is 3.2 millimeters, the distance 122 between the surface plane 112 and the weld plane 114 is 0.9 millimeters and the distance 120 between the thread starting plane 116 and the weld plane 114 is 4.1 millimeters. The angle 113, therefore, would be approximately 20.27 degrees and for this example, an angle 113 equaling approximately 20 degrees would be sufficient. Those skilled in the art, however, will appreciate that the distances 118, 120, and 122 may be varied and selected to maintain a predetermined value (such as 20.27 degrees) of the angle 113 and that the angle 113 may be varied from the example described above while remaining within the scope of the present invention.

The threads 105a formed in the surface 105 of the aperture 104, therefore, are protected from molten metal during the projection welding process without requiring the use of the pilot 24 of FIGS. 1 and 2 or similar structure, advantageously reducing the potential of shunting the weld current during the projection welding process. The fastener body 102 in accordance with the present invention also does not require a large footprint, as shown in the fastener body 52 of FIGS. 3 and 4, for spacing the projections 114 away from the fastener body 102 because the separation of the thread starting plane 116 and the weld plane 115 does not require the projections to be spaced radially outwardly from the aperture 104.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A weld fastener for use in a projection welding process, comprising:
a fastener body having a planar surface having at least one weld projection extending therefrom, said at least one weld projection having a free end spaced from said planar surface, said free end of said at least one weld projection defining a weld plane, said fastener body having an interior wall defining an aperture extending through at least one end of said fastener body, a portion of said interior wall defining a thread starting plane, said weld plane and said thread starting plane being spaced apart by a first predetermined distance, said planar surface and said thread starting plane being spaced apart by a second predetermined distance.

2. The apparatus according to claim 1 wherein said interior wall includes a plurality of threads formed thereon.

3. The apparatus according to claim 1 wherein said weld fastener is a nut.

4. The apparatus according to claim 1 wherein said interior wall defining said aperture extends through both ends of said fastener body.

5. The apparatus according to claim 1 wherein said predetermined distance between said weld plane and said thread starting plane is determined by an angle between a free end of said at least one weld projection and said thread starting plane.

6. The apparatus according to claim 1 wherein said predetermined distance between said weld plane and said thread starting plane is approximately 4.1 millimeters.

7. The apparatus according to claim 1 wherein said thread starting plane and said planar surface are spaced apart by a predetermined distance.

8. The apparatus according to claim 7 wherein said predetermined distance between wherein said thread starting plane and said planar surface is approximately 3.2 millimeters.

9. The apparatus according to claim 1 wherein said at least one weld projection is a continuous projection.

10. The apparatus according to claim 1 wherein said at least one weld projection is a plurality of discrete weld projections.

11. The apparatus according to claim 1 wherein said interior wall includes a chamfered portion adjacent said thread starting plane.

12. A weld fastener assembly for use in a projection welding process, comprising:
at least one fastener body having a planar surface at least one weld projection extending therefrom, said at least one weld projection having a free end spaced from said planar surface, said free end of said at least one weld projection defining a weld plane, said fastener body having an interior wall defining an aperture extending therethrough, said interior wall including a plurality of threads formed thereon, a portion of said interior wall defining a thread starting plane, said weld plane and said thread starting plane being substantially parallel and spaced apart by a predetermined distance; and
a parent metal body having a working surface,
whereby when said free end of said at least one weld projection of said at least one said fastener body is placed in contact with said working surface of said parent metal and subjected to a projection welding process, excess molten material from said at least one weld projection is prevented from contacting said threads on said interior wall.

13. The apparatus according to claim 12 wherein said at least one weld projection is a continuous projection.

14. The apparatus according to claim 12 wherein said at least one weld projection is a plurality of discrete weld projections.

15. The apparatus according to claim 12 wherein said at least one weld fastener is a nut.

16. The apparatus according to claim 12 wherein said interior wall includes a chamfered portion adjacent said thread starting plane.

17. The apparatus according to claim 12 wherein said predetermined distance between said weld plane and said thread starting plane is determined by an angle between a free end of said at least one weld projection and said thread starting plane.

18. The apparatus according to claim 17 wherein said angle is approximately 20 degrees.

19. A method of welding a fastener body to a parent metal body, said parent metal body having a working surface, a fastener body including a planar surface having at least one weld projection extending therefrom to be fused to said parent metal body by the passage of electrical current through said at least one weld projection, said at least one weld projection having a free end spaced from said planar surface, said free end of said at least one weld projection defining a weld plane, said fastener body having an interior wall defining an aperture extending through at least one end of said fastener body, a portion of said interior wall defining a thread starting plane, said weld plane and said thread starting plane being spaced apart by a predetermined distance, comprising the steps of:
a) placing said fastener body on a working surface at a joining region of said parent metal body where said at least one projection abuts said working surface;
b) passing an electrical current directly through said planar surface, said at least one projection, and said working surface to fuse said at least one projection against said working surface, whereby excess molten material from said at least one weld projection is prevented from contacting said threads on said interior wall; and
c) stopping said electrical current to form a weld.
